(19) United States
(12) Patent Application Publication
(10) Pub. No.: US 2026/0078277 A1
(43) Pub. Date: Mar. 19, 2026

(54) WIND TURBINE BLADE

(71) Applicant: JOTUN A/S, Sandefjord (NO)

(72) Inventors: Pengpeng WANG, Wuxi (CN); Jakob Stensgaard DIGET, Sandefjord (NO)

(21) Appl. No.: 18/879,619

(22) PCT Filed: Jul. 5, 2023
(86) PCT No.: PCT/EP2023/068628

§ 371 Date: Dec. 27, 2024

(30) Foreign Application Priority Data
Jul. 5, 2022 (WO) PCT/CN2022/103899
Jul. 26, 2022 (EP) 22187078.5

(51) Int. Cl. C09D 175/06; C09D 7/48; F03D 1/06

(52) U.S. Cl. CPC C09D 175/06; C09D 7/48; F03D 1/0688; F05B 2230/90

(57) ABSTRACT

The invention relates to a wind turbine blade, preferably the leading edge of a wind turbine blade, coated with a coating composition comprising: (A) at least one polyaspartic selected from the group consisting of polyaspartic esters, polyetheraspartic esters and mixtures thereof; and (B) at least one aliphatic polyisocyanate prepolymer curing agent; wherein the component A further comprises a cycloaliphatic diamine aldimine.

### FIELD OF THE INVENTION

This invention relates to wind turbine blades, especially the leading edge of wind turbine blades, coated with a coating composition. In particular, the coating composition comprises at least one polyaspartic, at least one cycloaliphatic diamine aldimine and at least one aliphatic polyisocyanate prepolymer. The invention further relates to the use of the coating composition for wind turbine blades.

### BACKGROUND

A common challenge for the wind turbine industry is the wear and erosion of the wind turbine blades due to the high velocity at the tip of the blade combined with the collision of rain droplets and particulate material, such as dust or sand. The whirling arm rain erosion test (RET) is typically used to test durability.

Leading-edge protection (LEP) is applied to protect the part of the blade (leading edge) with the highest speed of rotation (often more than 300 km hr⁻¹). Typical coating systems for LEP comprise at least one basecoat (e.g., polyurethane or polyaspartic) and an LEP coating.

It has been shown that to obtain high rain erosion resistance (i.e. longest durability) it is important to have large tensile stress and strain values. Tensile properties are highly dictated by the nature of the binder matrix. An attractive binder matrix for LEP coatings is a polyaspartic. Typically employed as a two-component system, it is composed of a binder- and a curing agent component. Choosing the combination of binder and curing agent is therefore a crucial step in the development of a LEP coating. The choice/selection is based on tensile properties, molecular structure (chemical structure, number of functionalities, molecular weight etc.) and physical properties (solubility, T_{g}, viscosity, etc.).

Obtaining the right combination of binder(s) and curing agent(s) for a polyaspartic LEP system that results in high tensile values is therefore highly important, but also not a trivial job with the very many available combinations.

It is thus an object of the present invention to provide a wind turbine blade which is coated with a coating composition which possesses improved tensile properties and durability. Ideally, the coating composition should maintain the properties after exposure to UV-light, be easy to apply, have acceptable pot life and be fast drying. It is also desirable that the coating has good adhesion to the underlying coating and/or substrate, and few film defects. The present inventors have surprisingly found that a wind turbine blade coated with a coating composition comprising a combination of at least one polyaspartic and at least one aliphatic polyisocyanate prepolymer offers an attractive solution. In particular, the inventors have found that such coating compositions, further comprising a cycloaliphatic diamine aldimine possess attractive properties.

### SUMMARY

Thus, in a first aspect, the invention provides a wind turbine blade, preferably the leading edge of a wind turbine blade, coated with a coating composition comprising:
(A) at least one polyaspartic selected from the group consisting of polyaspartic esters, polyetheraspartic esters and mixtures thereof; and
(B) at least one aliphatic polyisocyanate prepolymer curing agent;
wherein the component (A) further comprises a cycloaliphatic diamine aldimine.

In a further aspect, the invention provides a wind turbine blade, preferably the leading edge of a wind turbine blade, coated with a coating composition comprising:
(A) at least one polyaspartic selected from the group consisting of polyaspartic esters, polyetheraspartic esters and mixtures thereof; and
(B) at least one aliphatic polyisocyanate prepolymer curing agent;
wherein the component (A) further comprises a cycloaliphatic diamine aldimine and component (B) further comprises an aliphatic polyisocyanate which is different to the at least one aliphatic polyisocyanate prepolymer curing agent.

In a further aspect, the invention provides the use of a coating composition as hereinbefore defined for coating at least part of a wind turbine blades, preferably the leading edge of a wind turbine blade.

### Definitions

A leading-edge protection (LEP) coating is used herein to refer to a coating which is applied to protect the peripheral part of the blade (leading edge) with the highest speed of rotation (often more than 300 km hr⁻¹). Primer, mid-coat, topcoat and tiecoat are all well-known terms in the art.

Where “molecular weight” is quoted for a particular component, we refer to the theoretical value for the molecular weight of the ideal molecule. It is typically used for small molecules.

Where “number average molecular weight (Mₙ)” is quoted for a particular component (typically a polymeric component) we mean the total weight divided by the total number of molecules. Mₙ is a value obtained analytically, e.g., via end-group analysis or GPC.

By “curing” in the context of the present invention, it is meant a process in which a solid layer of the coating system is obtained from the liquid components. The curing may take place, for example, via a chemical reaction and/or via evaporation of solvent. It will be understood that the curing reaction may not always be complete, for example, there may be unreacted functional groups, such as isocyanate groups, remaining after “curing” has taken place. Thus, by “curing”, “cured” or “allowing to cure” we cover both the scenarios of partial and complete curing.

By “coated” in the context of the present invention, we mean at least partly coated. Thus the coating compositions may coat part or all of the wind turbines blade.

### DETAILED DESCRIPTION

The invention relates to a wind turbine blade coated with a coating composition comprising at least one polyaspartic component (A) and at least one aliphatic polyisocyanate prepolymer component (B). Furthermore, the coating composition comprises a cycloaliphatic diamine aldimine in component (A).

### Component (A)

Component (A) comprises at least one polyaspartic selected from the group consisting of polyaspartic esters, polyetheraspartic esters and mixtures thereof.

In one embodiment, component (A) contains only one polyaspartic. Thus, in this embodiment, the polyaspartic consists of a polyaspartic ester or a polyetheraspartic ester, preferably a polyaspartic ester.

In an alternative embodiment, component (A) comprises a mixture of at least one polyaspartic ester and at least one polyetheraspartic ester. In this embodiment, the weight ratio of the at least one polyaspartic ester to the at least one polyetheraspartic ester is preferably in the range 99:1 to 1:99, more preferably 80:20 to 20:80, 75:25 to 25:75, even more preferably 50:50.

Any suitable polyaspartic ester may be used, however typically the polyaspartic ester is a polyaspartic ester comprising sterically hindered secondary amines and ester groups. Suitable polyaspartic esters are described in, for example, WO2016049104 A1.

The polyaspartic ester may include one or more polyaspartic esters corresponding to formula (I):

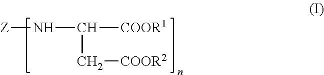

wherein: n is an integer of 2 to 6; Z represents an aliphatic residue; and R¹ and R² represent organic groups that are inert to isocyanate groups under reaction conditions and that may be the same or different organic groups.

In formula (I), the aliphatic residue Z may correspond to a straight or branched alkyl and/or cycloalkyl residue of an n-valent polyamine that is reacted with a dialkylmaleate in a Michael addition reaction to produce a polyaspartic ester.

For example, the residue Z may correspond to an aliphatic residue from an n-valent polyamine including, but not limited to, ethylene diamine; 1,2-diaminopropane; 1,4-diaminobutane; 1,6-diaminohexane; 2,5-diamino-2,5-dimethylhexane; 2,2,4- and/or 2,4,4-trimethyl-,6-diaminohexane; 1,11-diaminoundecane; 1,12-diaminododecane; 1-amino-3,3,5-trimethyl-5-amino-methylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a Mₙ of 148 to 6000 g mol-1; isomers of any thereof, and combinations of any thereof.

In certain embodiments, the residue Z may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

In certain embodiments, the polyaspartic ester comprises one or more compounds corresponding to formula (I) in which n is an integer from 2 to 6, in some embodiments n is an integer from 2 to 4, and in some embodiments n is 2.

Examples of commercially available polyaspartic esters are Desmophen NH1220, NH1420, NH1422, NH1423, NH1520, NH1521, NH1423 LF, and NH1523 LF all from Covestro, and F220, F221, F420, F421, F520 all from Feiyang, and IC20 and IC40 from Evonik.

Any suitable polyetheraspartic ester may be used, however typically the polyetheraspartic ester is one having the formula (II) below

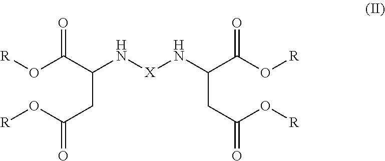

wherein each R represents a linear or branched C₁-C₁₀ alkyl residue, such as a linear or branched C₁-C₆ alkyl residue, such as for example a methyl, ethyl, propyl or butyl residue; and wherein X is a polyether.

In one embodiment, the invention relates to coating compositions comprising a blend of polyetheraspartic esters wherein X is a polyether having a repeat unit of the structure:

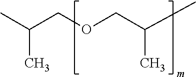

wherein m is in the range of 2 to 35.

The blend of polyetheraspartic esters may comprise at least two different polyetheraspartic esters which have a different number of repeating units in X. In one embodiment, the blend is such that the average value of m is in the range of 2 to 10, such as 2 to 6, such as 2 to 4, such as 2.5 to 3.

Polyetheraspartic esters may be prepared by reacting one or more polyether polyamines with a dialkylmaleate, such as for example a linear or branched C₁-C₁₀ dialkyl maleate, such a linear or branched C₁-C₆ dialkyl maleate, such as for example diethyl maleate. Said polyetheraspartic esters may be prepared, for example, by employing the reactants in amounts such that there is at least one equivalent, and in some embodiments approximately one equivalent, of olefinic double bonds for each equivalent of primary amino groups. Examples of methods for the preparation of polyetheraspartic esters can be found in WO 2014/151307 and in Chen et al., RSC Advances (2018), 8:13474-13481.

Suitable polyether polyamines that may be reacted with dialkylmaleates in Michael addition reactions to produce polyetheraspartic esters for the coating compositions of the invention include the Jeffamine polyetheramines commercially available from Fluntsman Corporation, The Woodlands, TX; for example polyetheramines from the Jeffamine D series, such as for example Jeffamine D-230.

In one embodiment, the blend of polyether polyamines comprises a blend of polyether polyamines according to formula (III) below,

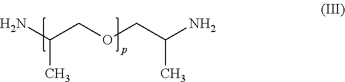

wherein p is a number having an average value of at least 2, such as 2 to 35, or 2 to 8, or 2.5 to 6.1 wherein the blend comprises: (1) about 50 to 99 wt %, such as 50 to 90 wt %, or, in some cases, 80 to 90 wt %, of polyether polyamines according to the formula wherein p has an average value of 2.5; and (2) about 1 to 50 wt %, such as 10 to 50 wt % or, in some cases, 10 to 20 wt %, of polyether polyamines according to the formula wherein p has an average value of 6.1.

Examples of blends of polyetheraspartic esters that are suitable for use in the present invention are Desmophen NH 1720 (previously Desmophen NH2850XP) and Desmophen NH 1723 LF, from Covestro, which both have an equivalent weight of about 290-295 g mol⁻¹, a viscosity at 25° C. of ≥80 mPa·s, and an amine value between 170-210 mg KOH/g.

Component (A) further comprises a cycloaliphatic diamine aldimine, preferably an isophorone diamine aldimine, such as Vestamin A-139 from Evonik. Suitable aldimines include, but are not limited to, 1,3,3-trimethyl-N-(2-methylpropylidene)-5-[(2-methylpropylidene)amino]cyclohexanemethylamine. Aldimines comprise the group RCH═NR or RCH═NH, i.e. formed by the condensation of an aldehyde with an primary or secondary amine. Preferably the aldimine is of structure RCH═NR.

Cycloaliphatic diamine aldimines of the invention preferably comprise a 5 or 6 membered aliphatic carbon ring. That ring may be substituted by alkyl groups, such as C1-4 alkyl groups.

The N atom of the imine may be bound to the carbon ring or may be separated from the ring by a further alkylene chain. It is preferred if the cycloaliphatic diamine aldimine comprises two nitrogen atoms. It is preferred if the aldimine of the invention comprises at least two aldimine groups, such as two aldimine groups. It is preferred aldimine of the invention contains only C, H and N atoms. In one embodiment, the aldimine will have a molecular weight of less than 400 g mol⁻¹.

Any suitable cycloaliphatic diamine aldimine may be used and includes those prepared from an aldehyde and polyamines containing two or more, preferably 2 to 6 and more preferably 2 to 4, primary amino groups. The polyamines include high molecular weight amines having molecular weights in g mol⁻¹ of 400 to about 10,000, preferably 800 to about 6,000, and low molecular weight amines having molecular weights below 400. Examples of these polyamines are those wherein the amino groups are attached to aliphatic or, preferably, cycloaliphatic carbon atoms.

Suitable low molecular weight polyamines starting compounds include tetramethylene diamine, ethylene diamine, 1,2- and 1,3-propane diamine, 2-methyl-1,2-propane diamine, 2,2-dimethyl-1,3-propane diamine, 1,3- and 1,4-butane diamine, 1,3- and 1,5-pentane diamine, 2-methyl-1,5-pentane diamine, 1,6-hexane diamine, 1,7-heptane diamine, 1,8-octane diamine, 1,9-nonane diamine, 1,10-decane diamine, 1,11-dodecane diamine, 1-amino-3-aminomethyl-3,5,5-trimethyl cyclohexane, 4,4′-, 2,4′- and 2,2′-diamino dicyclohexyl methane, bis-(4-amino-3-methylcyclohexyl)-methane, 1,2- and/or 1,4-cyclohexane diamine, 1,3-bis(methylamino)-cyclohexane, 1,8-p-menthane diamine, hydrazine, hydrazides of semi-carbazido carboxylic acids, bis-hydrazides, bis-semicarbazides, N,N,N-tris-(2-aminoethyl)-amine, guanidine, N-(2-aminoethyl)-1,3-propane diamine, polyoxypropylene amines, polyoxyethylene amines, and mixtures thereof.

Preferred polyamines are 1-amino-3-aminomethyl-3,5,5-trimethyl-cyclohexane (isophorone diamine or IPDA), 4,4′-, 2,4′- and 2,2′-diamino dicyclohexyl methane, bis-(4-amino-3-methylcyclohexyl)-methane, 1,6-diaminohexane, 2-methyl pentamethylene diamine and ethylene diamine. 4,4′-diamino-dicyclohexyl-methane, optionally in a mixture with its isomers.

Suitable high molecular weight polyamines correspond to the polyhydroxyl compounds as defined below which are used to prepare the NCO prepolymers with the exception that the terminal hydroxy groups are converted to amino groups, either by amination or by reacting the hydroxy groups with a diisocyanate and subsequently hydrolyzing the terminal isocyanate group to an amino group. Preferred high molecular weight polyamines are amine-terminated polyethers such as the Jeffamine resins available from Texaco.

Suitable aldehydes are those corresponding to the formula

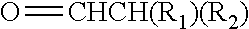

wherein R₁ and R₂ may be the same or different and represent aliphatic hydrocarbon radicals, preferably containing 1 to 10, more preferably 1 to 6, carbon atoms, or R₁ and R₂ together with the β-carbon atom form a cycloaliphatic ring. At least one of the aldehyde or polyamine reactants comprises a cycloaliphatic ring.

Examples of suitable aldehydes include isobutyraldehyde, 2-ethyl hexanal, 2-methyl butyraldehyde, 2-ethyl butyraldehyde, 2-methyl valeraldehyde, 2,3-dimethyl valeraldehyde, 2-methyl undecanal and cyclohexane carboxyaldehyde.

The aldimines may be prepared in a known manner by reacting the polyamines with the aldehydes either in stoichiometric amounts or with an excess of aldehyde. The excess aldehyde and the water which is produced can be removed by distillation. The reactions may also be carried out in solvents, other than ketones. The solvents may also be removed by distillation after completion of the reaction.

A particularly preferred aldimine is an isophoronediamine aldimine, for example as Vestamin A-139 from Evonik.

It will be appreciated that in the presence of moisture, aldimines are unstable, and they may be stored as a third component to maintain functionality. To maintain the aldimine functionality it is possible also to use moisture scavengers such as molecular sieves, oxazolidines, p-Toluenesulfonyl Isocyanate, etc., The cycloaliphatic diamine aldimine may be present in an amount of 3 to 30 wt %, preferably 10 to 20 wt %, relative to the total weight of the at least one polyaspartic and aldimine combined. Component (A) may comprise 30 to 80 wt % of the polyaspartic component, such as 40 to 70 wt %. The component (A) may comprise 2.0 to 15 wt % of the aldimine component, such as 3.0 to 12 wt %.

Any individual additional component, such as pigment, extender etc., may form up to 35 wt % of component (A) such as up to 30 wt % of component (A). The total of additional components in component (A), i.e. those other than the polyaspartic and aldimine components, may be 75 wt % or less, such as 50 wt % of less.

It should be realized that component (A) may further comprise other resins/binders known in the art to form a chemical bond with isocyanates. These include, but are not limited to, polyamines and polyols of polyethers, polyesters, polycarbonates, polyvinyls and polyacrylics. As other binders, polycarbonate polyols are particularly preferred. Such binders are well known in the art and are available commercially.

### Component (B)

Component (B) comprises at least one aliphatic polyisocyanate prepolymer curing agent. By “aliphatic” in this context we mean that the prepolymer is aliphatic throughout its entire structure, i.e. both the backbone and end groups are aliphatic. Suitable poly-isocyanate prepolymers are well known in the art.

Polyisocyanate prepolymers of use in the invention are most commonly manufactured by reacting (urethanization) excess diisocyanates with long-chain polyols that are often difunctional, especially polyether, polyester and polycarbonate polyols, with the excess of monomeric diisocyanate removed.

Polyisocyanate prepolymers may therefore contain urethane linkages and will often have isocyanate functionality of about 2.

They may also be manufactured by reaction of thiol or amine functional compounds with diisocyanates. In the latter case, polyurea is formed.

The end result is a compound with isocyanate functionality at the termini instead of hydroxyls. The polyisocyanate prepolymer preferably therefore contains one or more urethane and/or urea (not including carbamylurea of biuretes) linkages. In particular, the polyisocyanate prepolymer preferably contains one or more urethane linkages.

The polyisocyanate prepolymers most relevant in the present case have functionality of about 2 and contain urethane or urea linkages. It is preferred if the polyisocyanate prepolymers are not allophanates nor uretdiones.

Aliphatic polyisocyanates of the invention preferably comprise at least 3 isocyanate groups, i.e. have a functionality of three or more. For the polyisocyanate prepolymers, functionality is typically less than 3, e.g. up to 2.5 and typically about 2.

Examples of suitable aliphatic monomeric polyisocyanates include hexamethylene diisocyanate (HDI), 2,2,4- and/or 2,4,4-trimethyl-1,6-hexamethylene diisocyanate, dodecamethylene diisocyanate, 1,4-diisocyanatocyclohexane, 1-isocyanato-3,3,5-trimethyl-5-isocyanatomethylcyclohexane (IPDI), 1,5-pentamethylene diisocyanate (PDI) and 2,4′- and/or 4,4′-diisocyanato-dicyclohexyl methane (H₁₂MDI).

Commercial examples of these monomeric polyisocyantaes include:
Desmodur H, ex Covestro, monomeric aliphatic diisocyanate, HDI, equivalent weight 84, functionality 2.
Desmodur I, ex Covestro, monomeric aliphatic diisocyanate, IPDI, equivalent weight 111, functionality 2.
Desmodur W, ex Covestro, monomeric aliphatic diisocyanate, H12MDI, equivalent weight 131, functionality 2.
Desmodur ECO N 7300, aliphatic polyisocyanate, PDI trimer, 21.5% NCO by weight on supply form, functionality 3.7.

The pre-polymers may be prepared from polyhydroxyl or amine compounds having a molecular weight of 62 to 299 g mol⁻¹. Examples include ethylene glycol, propylene glycol, trimethylol propane, 1,6-dihydroxy hexane; low molecular weight, hydroxyl-containing esters of these polyols with dicarboxylic acids of the type exemplified hereinafter; low molecular weight ethoxylation and/or propoxylation products of these polyols; and mixtures of the afore-mentioned polyvalent modified or unmodified alcohols.

Preferably the pre-polymers are prepared from relatively high molecular weight (e.g. greater than 299 g mol⁻¹) polyhydroxyl compounds. These polyhydroxyl compounds have at least two hydroxyl groups per molecule and more preferably have a hydroxyl group content of 0.5-17% by weight, preferably 1-10% by weight.

The polyisocyanate prepolymers generally have an isocyanate content of 0.5-30% by weight, preferably 1-20% by weight, and are prepared in a known manner by the reaction of the required starting materials at an isocyanate (NCO)/hydroxyl (OH) equivalent ratio of 1.05:1 to 10:1 preferably 1.1:1 to 3:1, this reaction being optionally followed by distillative removal of any un-reacted volatile starting polyisocyanates still present. Particularly preferred prepolymers are IPDI prepolymers and HDI prepolymers.

In one embodiment the NCO content in wt % of the preferred polyisocyanate prepolymers of invention is lower than the NCO content of the aliphatic polyisocyanates. The polyisocyanate prepolymers of the invention may have an NCO content of 11 wt % or lower. The aliphatic polyisocyanates of use in the invention may have an NCO content of 11.5 wt % or more.

Preferably, the prepolymer will have an isocyanate functionality of 1.2 to 3.5, preferably 1.5 to 3.0, more preferably 1.8 to 2.2, such as 2.

Commercially available isocyanate prepolymers from Covestro:
Desmodur E 40480 MPA, aliphatic IPDI prepolymer (previously named Desmodur XP2406) (2.4-3.2% NCO by weight on supply form), functionality 2.
Desmodur E2863 XP, aliphatic HDI prepolymer (approximately 11% NCO by weight on supply form), functionality 2.2.
Desmodur XP2599, aliphatic HDI prepolymer (5.5-6.5% NCO by weight on supply form).
ANDUR AL80-5AP, aliphatic polyether from Anderson Development Company, polytetramethylene ether glycol (PTMEG) and H₁₂MDI (3.8-4.2% NCO by weight on supply form).
   Prepolymers from Lanxess:
Adiprene® LFH E520 HDI Polyether, 5.00-5.40% NCO by weight on supply form.
Adiprene® LFH E710 HDI Polyether, 6.80-7.40% NCO by weight on supply form, functionality 2.
Adiprene® LFH C840 HDI Polycaprolactone, 8.20-8.60% NCO by weight on supply form.
Adiprene® LFH R600 HDI Polycarbonate, 5.60-6.40% NCO by weight on supply form.
Adiprene® LW 520 H₁₂MDI Polyether, 4.60-4.90% NCO by weight on supply form.
Adiprene® LW 570 H₁₂MDI Polyether, 7.35-7.65% NCO by weight on supply form.
Trixene® SC 7902 IPDI Polyether, 3.90-4.10% NCO by weight on supply form.
Trixene® SC 7930 HDI Biuret Castor Oil, 9.00-12.00% NCO by weight on supply form.
Trixene® SC 7931 IPDI Polyether, 2.70-3.20% NCO by weight on supply form, functionality 2.
Trixene® DP9A/997 IPDI Polyether, 3.50-4.00% NCO by weight on supply form.

Component (B) may further comprise an aliphatic polyisocyanate, which is different to the at least one aliphatic isocyanate prepolymer curing agent. Suitable aliphatic polyisocyanates are well known in the art. The aliphatic polyisocyanate is preferably free of any urethane linkages. The aliphatic polyisocyanate is preferably free of any urea linkages.

In preferred coating compositions of the present invention the aliphatic polyisocyanate is a derivative of the above-mentioned monomeric polyisocyanates, as is conventional in the art. These derivatives include polyisocyanates containing biuret groups. Examples of particularly preferred derivatives include N,N′,N″-tris-(6-isocyanatohexyl)-biuret and mixtures thereof with its higher homologues and N,N′,N″-tris-(6-isocyanatohexyl)-isocyanurate and mixtures thereof with its higher homologues containing more than one isocyanurate ring.

In a particularly preferred embodiment, the aliphatic polyisocyanate is an isocyanate biuret or is an isocyanate trimer, most preferably an isocyanate trimer.

Examples of suitable commercially available polyisocyanates are:

### From Covestro:

Desmodur N3900 (formerly VP2410, aliphatic polyisocyanate, aliphatic polyisocyanate, based on HDI, 23.5% NCO by weight on supply form, functionality 3.2
Desmodur N3600, aliphatic polyisocyanate, HDI trimer, 23% NCO by weight on supply form, functionality 3.2.
Desmodur N3800, aliphatic polyisocyanate, HDI trimer, 11% NCO by weight on supply form, functionality 3.8.
Desmodur N3300, aliphatic polyisocyanate, HDI trimer, 23% NCO by weight on supply form, functionality 3.5.
Desmodur N3390, aliphatic polyisocyanate, HDI trimer, 19.6% NCO by weight on supply form, functionality 3.5.
Desmodur N100, aliphatic polyisocyanate, HDI biuret, 22% NCO by weight on supply form, functionality 3.8.
Desmodur N 3200, aliphatic polyisocyanate, HDI biuret, 23% NCO by weight on supply form, functionality 3.5.
Desmodur N75 BA, MPA or MPA/X, aliphatic polyisocyanate, HDI biuret, 16.5% NCO by weight on supply form, functionality 3.8.
Bayhydur VP LS 2319, aliphatic polyisocyanate.
Desmodur Z 4470 BA, aliphatic polyisocyanate, IPDI trimer, 11.9% NCO by weight on supply form, functionality 3.5.
Desmodur NZ 300, aliphatic polyisocyanate, mix of HDI and IPDI.

### From Vencorex:

Tolonate HDT-LV2, ex. Vencorex), aliphatic polyisocyanate.
Tolonate HDT90, aliphatic polyisocyanate
Tolonate IDT 70B, aliphatic polyisocyanate, IPDI trimer/homopolymer, 11.3-13.3% NCO by weight on supply form.

### From BASF:

Basonat HI 190 B/S, aliphatic polyisocyanate.
Basonat HB 175 MP/X, aliphatic polyisocyanate HDI biuret, 16-17% NCO by weight on supply form.
Basonat HB 100, aliphatic polyisocyanate HDI biuret, 22-23% NCO by weight on supply form.
Basonat HB 275 B, aliphatic polyisocyanate HDI biuret, 16-17% NCO by weight on supply form.

If present, the aliphatic polyisocyanate, which is different to the aliphatic isocyanate prepolymer curing agent, is preferably present in an amount which is less than the amount of the aliphatic polyisocyanate prepolymer curing agent. For example, the aliphatic polyisocyanate may be present in an amount of 2.5 to 30 wt %, such as 5 to 15 wt %, relative to the total weight of the at least one aliphatic polyisocyanate prepolymer curing agent and aliphatic polyisocyanate combined.

Component (B) may comprise 70 wt % or more of the aliphatic polyisocyanate prepolymer curing agent. In some embodiments, component (B) consists of the aliphatic polyisocyanate prepolymer curing agent. Component (B) may also comprise 2.5 to 30 wt % such as 5.0 to 15 wt % of the at least one aliphatic polyisocyanate.

### Other Components

The coating composition of the present invention may also include other substances commonly used in coating formulations such as extenders, pigments, matting agents, solvents and additives such as waxes, dyes, dispersants, wetting agents, defoamers, surfactants, adhesion promoters, light stabiliser (e.g. hindered amine light stabiliser (HALS) and/or UV absorber(s)), water scavengers and thixotropic agents.

In one preferred embodiment, the coating composition comprises a UV stabiliser and/or UV absorber. Particularly preferred UV stabilisers are HALS, such as bis(1,2,2,6,6-pentamethyl-4-piperidyl) sebacate. And Tinuvin 292 from BASF which is a mixture of bis(1,2,2,6,6-pentamethyl-4-piperidyl) sebacate and methyl 1,2,2,6,6-pentamethyl-4-piperidyl sebacate

In one particular embodiment, the coating composition comprises an adhesion promoter. Examples of suitable adhesion promotors include alkoxy silanes such as those known under the tradename Dynasylan from Evonik, for example Dynasylan AMEO and Dynasylan 1189, and known as Silquest from Momentive such as A1524 (similar to VPS 2101 from Evonik, 3-ureidopropyltrimethoxysilane), and NCO-alkoxysilane hybrids such as Desmodur® 2873 from Covestro.

Additives in total will typically form up to about 25 wt %, e.g. up to 20 wt %, ideally up to 15 wt %, based on the total weight of the coating composition as a whole. Additives might be present in as little as 1 wt % or less of the composition.

Examples of extenders are minerals such as dolomite, plastorite, calcite, quartz, barite, magnesite, silica, nepheline syenite, wollastonite, talc, chlorite, mica, kaolin, pyrophyllite and feldspar; synthetic inorganic compounds such as calcium carbonate, magnesium carbonate, barium sulphate, calcium silicate and silica; polymeric and inorganic microspheres such as uncoated or coated hollow and solid glass beads, uncoated or coated hollow and solid ceramic beads, porous and compact beads of polymeric materials such as poly(methyl methacrylate), poly(methyl methacrylate-co-ethylene glycol dimethacrylate), poly(styrene-co-ethylene glycol dimethacrylate), poly(styrene-co-divinylbenzene), polystyrene, poly(vinyl chloride). Pigments of interest include organic pigments and inorganic pigments such as titanium dioxide.

Preferable examples of suitable solvents are organic solvents such as toluene, xylene and naphtha solvent; ketones such as methyl ethyl ketone, methyl isobutyl ketone, diacetone alcohol and cyclohexanone; esters such as methoxypropyl acetate, n-butyl acetate and 2-ethoxyethyl acetate; and mixtures thereof. Particularly preferred solvents are esters such as n-butyl acetate, t-butyl acetate, 1-methoxy-2-propyl acetate, most preferred n-butyl acetate and/or 1-methoxy-2-propyl acetate.

Solvent preferably forms less than 20 wt % of the coating composition. It will be appreciated that the wt % ranges for the solvent are relative to the coating composition before curing (i.e. before the coating is cured and dried). Any pigments preferably make up 10 to 30 wt %, e.g. 15 to 25 wt %, relative to the total weight of the coating composition. Extenders typically preferably make up 0 to 40 wt %, such as 2.5 to 30 wt %, e.g. 5 to 20 wt %, relative to the total weight of the coating composition.

Any additional component can be considered as part of component (A).

### Coating Composition

In a preferred embodiment, the coating composition of the invention is curable at ambient temperature, preferably at room temperature, i.e. when the components are mixed the coating composition will cure at the temperature in the environment in question without the application of heat. That might typically be in the range of 5 to 50° C. Preferably, curing occurs at 10 to 35° C., more preferably at room temperature, i.e. in the range 15 to 30° C. It will be understood that since the coating compositions of the invention are curable they may be referred to as curable coating compositions.

The coating composition is preferably made up of several parts (e.g. two or more parts) to prevent premature curing and hence is shipped as a kit of parts. The components should be combined and thoroughly mixed before use. Conventional mixing techniques can be used.

In one embodiment, the coating composition of the invention may be supplied as a 3-component kit of parts to maximise the storage stability of the coating composition. Inventors have found that storage stability can be compromised if the coating composition is supplied as a two component kit with curing agent and polyaspartic in separate containers. It is preferred therefore if the aldimine is added just before application of the coating composition (A) to the substrate. This prevents premature reaction or inactivation of the aldimine.

The polyaspartic component (A), aldimine component and curing agent component are preferably supplied therefore in separate containers for mixing shortly before application to the wind turbine blade.

Viewed from another aspect therefore the invention provides a kit of parts suitable for the production of the coating composition of the invention comprising
a first container comprising at least one polyaspartic selected from the group consisting of polyaspartic esters, polyetheraspartic esters and mixtures thereof;
a second container comprising at least one aliphatic polyisocyanate prepolymer curing agent;
a third container comprising a cycloaliphatic diamine aldimine.

It will be appreciated that to ensure storage stability the first container container is free of the curing agent and aldimine, the second container is free of the polyaspartic and aldimine and the third container free of the polyaspartic and curing agent.

If a two component system is used, then the use of a water scavenger, e.g. as discussed above, may improve the storage stability of the aldimine component.

The polyaspartic component (A) (i.e. the at least one polyaspartic plus aldimine) and the polyisocyanate component (B) (i.e. the at least one aliphatic polyisocyanate prepolymer plus optional aliphatic polyisocyanate) are typically present in amounts corresponding to a ratio of equivalents of NCO groups to the total number of amine (NH) groups of from 0.75-1.25:1, more preferably 0.9-1.1:1.

The weight ratio of the total formulation of component (A) to the total formulation of component (B), i.e. each of components (A) and (B) including additives and solvents is typically in the range 1:5 to 5:1, preferably 1:3 to 3:1 such as 1:2 to 2:1, e.g. 1:1.

In a preferable embodiment, the initial gloss (i.e. prior to exposure) of the coating composition, after curing, at 60° is more than 10 gloss units, preferably more than 20 gloss units, more preferably more than 30 gloss units.

The coating composition, after curing, preferably has a tensile strain of greater than 200%, more preferably greater than 250%, such as greater than 300%, when determined using a modified procedure based on ISO 527 at 23° C. as described under “Test Methods”.

The coating composition, after curing, preferably has a tensile stress of greater than 20 MPa, more preferably greater than 25 MPa, such as greater than 30 MPa, when determined using a modified procedure based on ISO 527 at 23° C. as described under “Test Methods”.

The coating composition of the invention preferably has a solids content of 75 wt % or higher, such as 80 wt % or higher, e.g. 85 wt % or higher, relative to the total weight of the coating composition.

The coating compositions of the invention, after curing, ideally have greater than 50% gloss retention measured at 60° after exposure to 2000 hrs QUV-A according to ISO 16474-3, Test Cycle 1.

The coating compositions of the invention, after curing, ideally have greater than 30% gloss retention measured at 60° after exposure to 2000 hrs QUV-B according ISO 11507 Method A.

### Coating System and Application

The coating compositions of the invention are utilised to coat wind turbine blades, preferably the leading edge of wind turbine blades. Typical turbine blades are composed of a material comprising a synthetic resin composite comprising an epoxy resin, a vinyl ester resin, polyurethane, glass or a carbon fiber reinforced resin. In a particularly preferred embodiment, the substrate is a leading edge of a wind turbine blade.

Thus, the invention relates to a wind turbine blade which is at least partly coated with the coating composition as hereinbefore defined. The invention also relates to the use of a coating composition as hereinbefore defined for coating at least part of a wind turbine blade, preferably the leading edge of a wind turbine blade.

The coating composition can be applied by any conventional method such as brushing, rolling or spraying (airless or conventional). Preferably, conventional spraying is used.

The layer formed using the coating composition of the invention preferably has a dry film thickness of 50 to 500 μm, more preferably 100 to 500 μm, such as 150 to 500 μm. It will be appreciated that any layer can be laid down using single or multiple applications of the coating. Preferably, 2 to 6 layers are applied, more preferably 2 to 4 layers.

The coating composition is typically applied as part of a coating system of more than one layer. In such systems, the coating composition of the present invention is preferably, but not necessarily, applied as the outermost layer. The composition of the invention can be applied onto any pre-treatment layers suitable for polyaspartic coating layers.

Typically, the interval between applying each layer is less than 24 hrs, preferably in the range 1 to 24 hrs, more preferably 1 to 12 hrs, such as 1 to 6 hrs, at 23° C. and 50% relative humidity.

The term “tiecoat” in the context of the invention means a layer of coating which acts as a bridge between, for example, a substrate, a primer or undercoat layer or a filler and a coating layer. It will thus be understood that, when we refer to the “substrate” or “surface of a substrate”, we mean the substrate itself or any pre-treatment layers which have been applied to at least part of the substrate. Thus, the coating composition of the invention may be applied directly to at least part of a substrate, or onto any pre-treatment layers designed for polyol, polyamine, polyaspartic ester or polyetheraspartic ester based polyurethane or polyurea topcoats.

In a preferred embodiment, the coating composition of the invention is applied as part of the following coating system: an optional filler layer (typically also referred to as a putty, e.g. polyurethane with a high extender content), a primer layer (e.g. polyurethane or polyurea), a tiecoat layer and a LEP coating layer, in that order, wherein the coating composition of the invention forms the LEP coating layer. Sometimes the LEP coating layer may be coated with another coating, but most often the LEP coating layer is the outermost coating layer in the coating system. Preferably, the primer is a waterbased, solvent based or solvent free polyurethane or polyaspartic coating. Preferably the filler is a polyurethane coating with a high solid content, preferably 80-100 wt % solids, typically more than 97 wt % solids.

The layers formed using the coating system of the invention preferably have a dry film thickness as follows: filler (0-2000 μm applied over 0-3 coats), primer (60-150 μm applied over 1-2 coats), tiecoat (20-50 μm applied over 1 coat), LEP coat (150-500 μm applied over 2-6 coats). It will be appreciated that any layer can be laid down using single or multiple applications of the coating depending on application method and area of use.

The invention will now be described with reference to the following non-limiting examples.

### EXAMPLES

### General Procedure for Preparation of the Compositions

The two components for various coating compositions were prepared by combining the respective constituents and homogeneously mixing them in a dissolver, in a manner known to the person skilled in the art. For each coating composition, the two components were homogeneously mixed in the proportions indicated in Table 1, where coating compositions are indicated with I=according to the invention and C=comparative.

### Test Methods

### Tensile Test—Stress and Strain

Stress and Strain were determined using a modified procedure based on ISO 527. Paint was applied onto Mylar film from Dupont to obtain a 200-250 μm dry film thickness coating sample after drying for 2 weeks at 23° C. and 50% RH. Samples with 10 mm width and 150 mm lengths were then tested at 200 mm per minute strain rate with a gauge length of 50 mm in a Testometric universal testing machine at 23° C.

### Solids Content

The solids content in the coating compositions was calculated in accordance with ASTM D5201.

### Drying Time

Drying time was evaluated at 23° C. and 50% RH using the Beck Koller method in accordance with ISO 9117-4:2012 at 120 μm wet film thickness (WFT) using a mechanical straight-line or circular drying-time recorder. The drying time is rated as follows:
F=Fast, i.e. hard dry in 6 hrs
M=Medium, i.e. hard dry in 6-24 hrs
S=Slow, i.e. not hard dry in 24 hrs

### Artificial Weathering

Aluminum panels were applied with 300 μm WFT LEP and exposure was commenced after 2 weeks drying at 23° C. and 50% RH as follows:
QUV-A, according to ISO 16474-3, following the Test Cycle 1. Test Cycle No 1:4 hrs UV-light at 60° C. with UVA-340 lamps (UVA-340, 0.83 W/m² irradiation at 340 nm) followed by 4 hrs condensation at 50° C. for a total of 1000 to 2000 hrs.
QUV-B, according to ISO 11507 Method A with UVB-313 nm lamps following the cycle: 4 hrs. UV light at 60° C. (Irradiance 0.71 w/m²) followed by 4 hrs. Condensation at 50° C. for a total of 1000 to 2000 hrs.

Gloss was measured at an angle of 60° according to ISO2813:2014 after 1000 hrs and 2000 hrs of exposure.

### Rain Erosion Test

Rain erosion testing was carried out following standard ASTM G73-10, where Glass Fiber Reinforced Polymer (GRP) panels of airfoil shape, the length of exposure zone of panel for droplet impact is 23 cm, were coated with a system of Primer+Tiecoat+coating composition. The tie coat composition (details provided below) was applied to a GRP test specimen coated with 70 μm DFT Jotatop BC100, a commercially available two-component polyurethane-based primer from Jotun A/S. The coatings were allowed to dry for 2 hrs before the LEP coats were applied.

The LEP coating compositions were prepared and applied on top of the 30 μm DFT tie coat. Typically curing took place by storage at 23° C. and 50% RH for two weeks. The coatings were applied in two layers with brush (2×150 μm DFT) with 2-3 hrs drying in between. The total dry film thickness of the cured coating was 300 μm.

A coated test panel was attached to each of the three rotor arms, and testing carried out at 1527 rpm=160 m/s, 15-35° C., rain intensity 30-35 mm/h, and inspected every 30 min to monitor visually the erosion. The time to erode the surface was used to compare the performance of the coatings systems with each other. The longer the coating system could withstand erosion the better.

### Materials

| | | | | Isocyanate | |
|---|---|---|---|---|---|
| | | | | content | |
| | | | Solid | [% on | Viscosity |
| | | | content | supply | @ 23° C. |
| Name | Description | Supplier | [% wt] | form] | [mPa · s] |
| Isocyanate 1 | Aliphatic | Covestro | 70 | 11.9 | 600 |
| | polyisocyanate, | | in n-butyl | | |
| | IPDI trimer | | acetate | | |
| | Desmodur Z | | | | |
| | 4470 BA, | | | | |
| Isocyanate | Prepolymer | Covestro | 80 | 2.8 | 7000 |
| prepolymer 1 | based on IPDI | | in 2- | | |
| | and | | methoxy- | | |
| | polycarbonate | | 1- | | |
| | polyol, | | methylethyl | | |
| | Desmodur E | | acetate | | |
| | 40480 MPA, | | | | |
| | functionality 2 | | | | |
| Isocyanate | Prepolymer | Lanxess | 100 | 4.75 | 10000-20000 |
| prepolymer 2 | based on | | | | |
| | H₁₂MDI and | | | | |
| | polyether | | | | |
| | polyol, | | | | |
| | Adiprene | | | | |
| | LW520 | | | | |
| Isocyanate | Prepolymer | Lanxess | 100 | 7.1 | ~1000 |
| prepolymer 3 | based on HDI | | | | |
| | and polyether | | | | |
| | polyol, | | | | |
| | Adiprene LFH | | | | |
| | E710, | | | | |
| | functionality 2 | | | | |

| | Description |
|---|---|
| Polyaspartic 1 | Polyaspartic ester, Desmophen NH1420, amine |
| | value 199-203 mg KOH/g (Covestro) |
| Polyaspartic 2 | Polyetheraspartic ester, Desmophen NH1720, |
| | amine value 170-210 mg KOH/g (Covestro) |
| Aldimine | Isophorone diamine aldimine, Vestamin A-139, |
| | amine value 390-410 mg KOH/g (Evonik) |
| Pigment | Titanium dioxide, TI-PURE R-706 (Dupont) |
| UV Stabilisers | Hindered amine light stabiliser |
| | (HALS) and UV absorber |
| Additives | Leveling agent, defoamer, dispersing agent, |
| | degasser, rheology modifier |
| Extender | Barium sulphate, AIRWHITE AW5 |
| Solvent | 2-methoxy-1-methylethyl acetate |

### Tiecoat

### A Two Component Composition:

Component A: 1 weight part of a mixture of 31.5 wt % Type 9 bisphenol A diglycidyl ether (BADGE) resin with 2500-4000 epoxy equivalent weight (EEW) and Mn of more than 3500 g/mol, 31.5 wt % PMA glycol ether and 37 wt % xylene.
Component B: 0.257 weight part of aromatic NCO based on toluene diisocyanate (75 wt % solids in ethyl acetate, 13.3 wt % NCO on supply form). Prior application, the two components are homogenously mixed and applied evenly onto the surface.

TABLE 1
Coating compositions by weight and results

| | IE1 | CE1 | IE2 | CE2 | IE3 | IE4 | IE5 |
|---|---|---|---|---|---|---|---|
| Component (A) | | | | | | | |
| Polyaspartic 1 | 43.5 | 48.4 | 43.5 | 48.4 | 38.7 | | 7.9 |
| Polyaspartic 2 | | | | | | 37.1 | 33.9 |
| Aldimine | 4.8 | | 4.8 | | 9.7 | 6.3 | 6.8 |
| Additives | 5.1 | 5.3 | 5.1 | 5.3 | 5.3 | 5.5 | 5.3 |
| Extender | 13.9 | 14.6 | 13.9 | 14.6 | 14.6 | 16.0 | 14.6 |
| Pigment | 25.5 | 26.9 | 25.5 | 26.9 | 26.9 | 29.5 | 26.9 |
| Solvent | 1.5 | 1.6 | 1.5 | 1.6 | 1.6 | 1.8 | 1.6 |
| UV Stabilisers | | 3.2 | 3.1 | 3.2 | | 3.5 | 3.2 |
| Component B | | | | | | | |
| Isocyanate 1 | | | | | | 21.4 | 24.0 |
| Isocyanate prepolymer 1 | | | | 269.5 | 322.6 | 170.9 | 191.6 |
| Isocyanate prepolymer 2 | 175.9 | | | | | | |
| Isocyanate prepolymer 3 | | 108.3 | 118.9 | | | | |
| NCO:(NH + OH) ratio | 1.05:1 | 1.05:1 | 1.05:1 | 1.03:1 | 1.03:1 | 1.02:1 | 1.03:1 |
| Stress(MPa)/strain (%)* | 47/408 | 11/750 | 26/575 | 18/555 | 32/475 | 31/475 | 27/423 |
| UV A (% GU ret 1000/2000 hrs) | 17/<10 | | 75/53 | | 46/41 | | |
| UV B (% GU ret 1000/2000 hrs) | <10/<10 | | 52/41 | | 42/39 | | |
| Drying time | M | M | M | S | S | M | M |
| Solid content | 98.7 | | 98.3 | | 81.0 | | |

*Values are given at break points = ultimate stress and strain values for the samples of table 1.

TABLE 2
RET results for GRP samples coated with topcoat, tiecoat and LEP.

| | System 1 | System 2 | System 3 |
|---|---|---|---|
| | (comparative | (comparative | (inventive |
| | example) | example) | example) |
| LEP coating | CE1 | CE2 | IE2 |
| composition | | | |
| Time before erosion | 1 | 2 | 18 |
| [hrs] | | | |

As evident from Table 1, addition of aldimine results in larger stress values which improves rain erosion resistance. By RET results of system 1 with CE1 (without aldimine) and system 3 IE2 (with aldimine) in Table 2, a significant improvement in RET results is furthermore observed when aldimine is added.

1. A wind turbine blade, coated with a coating composition comprising:
(A) at least one polyaspartic selected from the group consisting of polyaspartic esters, polyetheraspartic esters and mixtures thereof; and
(B) at least one aliphatic polyisocyanate prepolymer curing agent;
wherein the component (A) further comprises a cycloaliphatic diamine aldimine.

2. The wind turbine blade of claim 1, wherein component (B) further comprises an aliphatic polyisocyanate which is different to the at least one aliphatic polyisocyanate prepolymer curing agent.

3. The wind turbine blade of claim 1, wherein the polyaspartic in component (A) is a polyaspartic ester or a polyetheraspartic ester.

4. The wind turbine blade of claim 1, wherein component (A) comprises a mixture of at least one polyaspartic ester and at least one polyetheraspartic ester.

5. The wind turbine blade of claim 1, wherein the weight ratio of the at least one polyaspartic ester to the at least one polyetheraspartic ester is in the range 99:1 to 1:99.

6. The wind turbine blade of claim 1, wherein component (A) further comprises a UV stabilizer and/or a UV absorber.

7. The wind turbine blade of claim 1, wherein said cycloaliphatic diamine aldimine is an isophorone diamine aldimine.

8. The wind turbine blade of claim 1, wherein component (A) further comprises a cycloaliphatic diamine aldimine in an amount of 3 to 30 wt %, relative to the total weight of the at least one polyaspartic and aldimine combined.

9. The wind turbine blade of claim 1, wherein component (B) further comprises an aliphatic isocyanate, which is different to the at least one aliphatic polyisocyanate prepolymer curing agent, in an amount of 2.5 to 30 wt %, relative to the total weight of the at least one aliphatic polyisocyanate prepolymer curing agent and aliphatic polyisocyanate combined.

10. The wind turbine blade of claim 2, wherein the aliphatic polyisocyanate is an isocyanate trimer or biuret.

11. The wind turbine blade of claim 2, wherein the least one aliphatic polyisocyanate prepolymer curing agent has a functionality of 2.

12. The wind turbine blade of claim 1, wherein the at least one polyaspartic, and aldimine, and the at least one aliphatic polyisocyanate prepolymer, plus optional aliphatic polyisocyanate, are present in amounts corresponding to a ratio of equivalents of isocyanate (NCO) groups to the total number of NH groups of from 0.75-1.25:1.

13. The wind turbine blade of claim 1, wherein the weight ratio of component (A) to component (B) is in the range 1:5 to 5:1.

14. The wind turbine blade of claim 1, wherein said coating composition, after curing, has a tensile stress of greater than 20 MPa, when measured using a modified procedure based on ISO 527 at 23° C. as described under “Test Methods”.

15. (canceled)

16. A kit comprising a first container comprising at least one polyaspartic selected from the group consisting of polyaspartic esters, polyetheraspartic esters and mixtures thereof;
a second container comprising at least one aliphatic polyisocyanate prepolymer curing agent; and
a third container comprising a cycloaliphatic diamine aldimine.

17. The wind turbine blade of claim 1, wherein component (A) further comprises a hindered amine light stabiliser (HALS).

18. The wind turbine blade of claim 1, wherein the at least one polyaspartic, and aldimine, and the at least one aliphatic polyisocyanate prepolymer, plus optional aliphatic polyisocyanate, are present in amounts corresponding to a ratio of equivalents of isocyanate (NCO) groups to the total number of NH groups of from 0.9-1.1:1.

19. The wind turbine blade of claim 1, wherein the weight ratio of component (A) to component (B) is in the range 1:3 to 3:1.

20. The wind turbine blade of claim 1, wherein the weight ratio of component (A) to component (B) is in the range 1:2 to 2:1.

21. The wind turbine blade of claim 1, wherein said coating composition, after curing, has a tensile stress of greater than 25 MPa when measured using a modified procedure based on ISO 527 at 23° C. as described under “Test Methods”.
